(19) United States
(12) Patent Application Publication
(10) Pub. No.: US 2023/0339576 A1
(43) Pub. Date: Oct. 26, 2023

(54) ILLUMINATED TOW ROPE

(71) Applicant: WakesnWaves LLC, The Colony, TX (US)

(72) Inventor: Joshua Lewis, The Colony, TX (US)

(21) Appl. No.: 17/727,524

(22) Filed: Apr. 22, 2022

(51) Int. Cl. B63B 21/56; B63B 45/00; F21S 4/26

(52) U.S. Cl. CPC B63B 21/56; B63B 45/00; F21S 4/26; B63B 2021/566

(57) ABSTRACT

A system, method, or apparatus for towing that allows for illumination of a tow rope and/or other components of a towing system or apparatus. The illumination can be achieved through the use of light sources that are coupled to a power source. A tow rope having a length, and a portion of that length can have a strip comprising at least one light source. The strip is of a length that is less than the length of rope and coupled to a control system allows for coupling to the at least one light source. A set of protective layers can surround the strip, engaging the strip with the length of rope, and to prevent the strip from breaking when flexed with the rope. In some examples, the rope can have a first end having a loop, and second end coupled with a handle.

### BACKGROUND

### Technical Field

The present disclosure relates to towing systems. More particularly, and not by way of limitation, the present disclosure is directed to an apparatus, system, or method for an illuminated tow rope.

### Description of Related Art

When towing objects in any environment during dusk or at night it is beneficial to be able to see the position of the towing line or system. It would be advantageous to have an apparatus, system, or method for an illuminated tow rope that overcomes the disadvantages of the prior art. The present disclosure provides such a disclosure.

### BRIEF SUMMARY

The present disclosure is a system, method, or apparatus for towing that allows for illumination of a tow rope and/or other components of a towing system or apparatus. The illumination can be achieved through the use of light sources that are coupled to a power source.

Thus, in one aspect, the present disclosure is directed to a system for a tow rope where the tow rope has a length, and a portion of that length can have a strip comprising at least one light source. The strip is of a length that is less than the length of rope and coupled to a control system allows for coupling to the at least one light source. A set of protective layers can surround the strip, engaging the strip with the length of rope, and to prevent the strip from breaking when flexed with the rope. In some examples, the rope can have a first end having a loop, and second end coupled with a handle. In yet another example, the protective layer(s) are sufficiently thick to allow the rope to flex at ninety degrees over a length of five (5) feet. In some examples, the control system, and light source are contained within the protective layers. In yet another example, the handle and loop are not contained within the protective layers. In some examples, the control system, which allows for manipulation of light source(s), can be coupled to a power source to allow for illumination of the light source(s), where the power source and the control system are located closer to the proximal end (loop end) of the rope than the distal end (handle end).

In another aspect, the present disclosure is directed to a tow rope with a defined length and a strip having at least one light source. The length of the strip is less than the length of rope, and may have a control system coupled to the at least one light source. A set of protective layers surround the strip and the rope, cause the strip and rope to be engaged, and allow the set of protective layers to be sufficiently thick to prevent the strip from breaking when flexed the rope is flexed. In some examples, the set of protective layers have a cylindrical structure. In other examples, the length of rope may include a first end and a second end, where the first end may include a gap between the protective layer and rope in which a connector is fed from a control system to a power source. In yet other examples, the power source is a direct current voltage source. In other examples, the set of protective layers engage, at minimum, a portion of the length of rope comprising the strip and control system.

In yet another aspect, the present disclosure is directed to a method for lighting a tow rope. The length of rope can be trimmed to a specified length, and a strip that can include a light source can be prepared to engage a portion of the rope that is less than the overall length of the rope. A control system can be coupled to the light source or strip, which can be surrounded with a set of protective layers that are sufficiently thick to prevent the strip from breaking when flexed. In some examples, the set of protective layers are built to a sufficient thickness that the length of rope can flex less than 90 degrees over specified length. In other examples, the strip can be electrified from a power source that allows the control system to operate.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1 is an illustration of a use for a tow rope

FIG. 2 is an illustration of the tow rope system

FIG. 3 is an illustration of a tow rope handle

FIG. 4A is an illustration a second end of a tow rope

FIG. 4B is an illustration of the tow rope system

FIG. 5 is an illustration of the battery system

FIG. 6 is an illustration of the light control system

FIG. 7A is an illustration of the tow rope system

FIG. 7B is an illustration of the tow rope control system

FIG. 7C is an illustration of the tow rope system

### DETAILED DESCRIPTION

Embodiment of the disclosure will now be described.

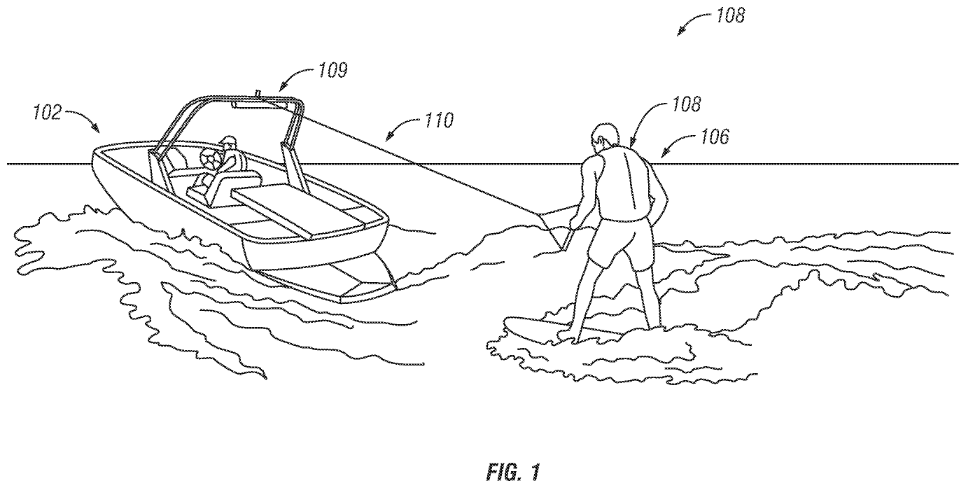

FIG. 1 is an illustration of a tow rope system 100 in operation with a watercraft 102. The tow rope system 100 allows for a watercraft 102 to be connected through a tow bar or system 104 that is coupled to a watercraft 102. It would be understood that other motorized or powered devices, apparatuses, systems, or vehicles could be utilized in place of a watercraft 102, including but not limited to unmanned systems, boats, cars, sport utility vehicles, all terrain vehicles, utility terrain vehicles, aircraft, or other forms of transportation.

The tow bar or system 104 can allow for the watercraft 102 to be connected to a user 106 via a tow rope 110. In at least one example, the tow rope 110 can be lighted to allow a user 106 in the watercraft 102 or utilizing the tow rope 110 to see where the user 106 and/or tow rope 110 is at any given moment. Additionally, the user 106 may utilize a life jacket 108 or other flotation device that is lighted in a similar manner as the tow rope 110.

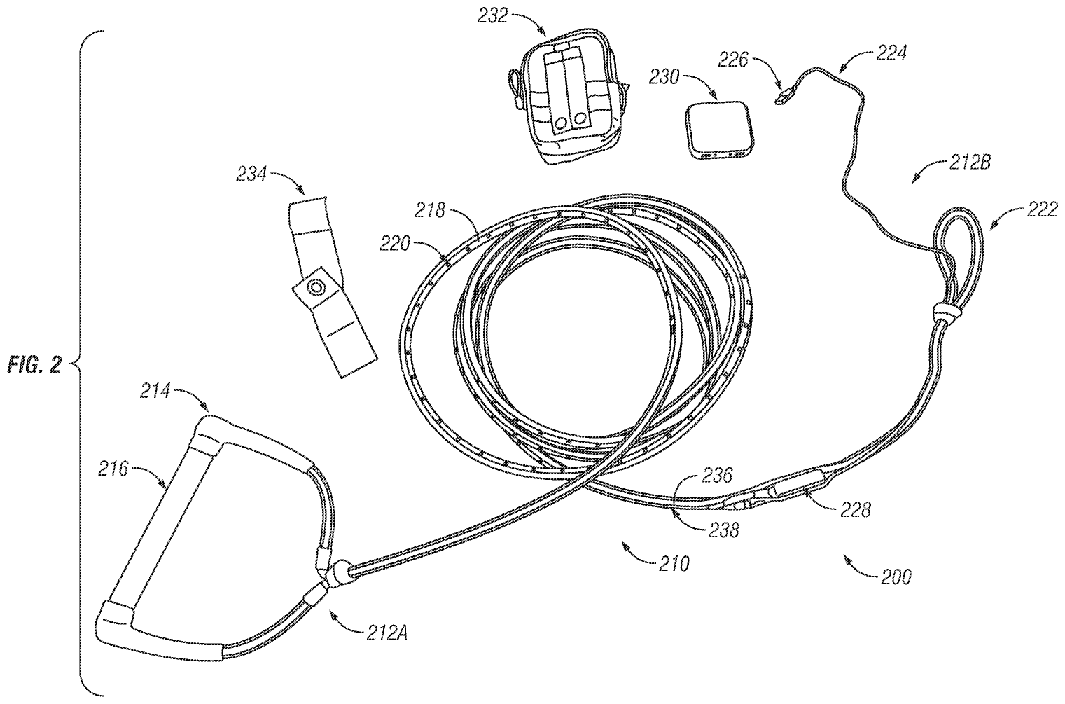

FIG. 2 is an illustration of lighted tow rope system 200. A lighted tow rope 210 can have any number of lengths. For example, the lighted tow rope 210 can be 1 ft. long, 10 feet long, 12 ft. long, 15 ft. long, 20 ft. long, 50 ft. long, 100 ft. long or any length in between. While feet have been used as the measure it would be understood that equivalent lengths such as inches, yards, centimeters, meters, and/or other units of length may also be utilized as a unit of measure. The length of lighted tow rope 210 may include a first end 212A and a second end 212B that are distal from one another. It would be understood that distal is utilized to mean at opposing end of the length of tow rope 210 and does not mean spatial reference as the first end 212A and the second end 212B may be next to one another in a storage configuration of the tow rope 210.

The first end 212A may have a handle 214 or other graspable apparatus capable of being integrated and/or coupled with the tow rope 210. In at least one embodiment, the handle 214 can have a handlebar 216 that a user (not illustrated) may grasp or hold on to for stability. In some examples, the handlebar 216 may be lighted in a similar manner to the lighted tow rope 210. For example, the lighted tow rope 210 and the handlebar 216 may have at least one light source each that operate in conjunction with one another to allow for visible identification of the tow rope 210. The lighting of the handlebar 216 can also improve safety during dusk, or nighttime use of the tow rope 210.

The second end 212B of the tow rope 210 may include a loop 222 or fastening point that allows for the connecting and/or coupling of the tow rope 210 to a tow bar or system (not illustrated). In at least one embodiment, the second end 212B may also include a set of wires or cable 224 or other electrically conductive mechanism to transfer electrical power from a power source. It would be understood that a set can include one or more of an item. The wire 224 can have a connector 226 that allows for connecting and/or engagement of the wire 224 with a power source 230.

The tow rope 210 can include a strip 218 having at least one light source 220. The strip 218 may include electrical components that allow for the completion of a circuit when the strip 218 is engaged with a power source through the wire 224 and/or connector 226. The light source 220 can include multi-color or single-color light sources. In the case of single-color light sources they may be combined or utilized in combination to create the appearance of a multi-color light source.

The lighted tow rope 210 can be coupled to a power source 230 that may comprise a battery or other chargeable or fixed power sources. A fixed power source is one that is steady, and/or consistently charging, for example an alternator or alternator charged battery, or other Alternating Current or Direct Current devices. The power source 230 and/or wire 224 and connector 226 may be placed within a storage pouch 232. In at least one embodiment, the storage pouch 232 is a liquid resistance to prevent corrosion or damage to the power source 230.

A controller 228 may be connected to the strip 218 and/or light source 220 for causing the strip 218 and/or light source 220 to activate in a particular order, color, and/or other combinations. In at least one example, the controller 228 can be protected by two or more layers of protective material to prevent breakage, damage, and/or corrosion from water, handling, and/or other sources. The controller 228 may include a processor or other computing device that allows for the controlling of the strip 218 and/or light source 220. The controlling may include intensity, brightness, color, order of individual light source(s), and/or other aspect of light-based controls.

A storage strap 234 may be utilized to assist in keeping the lighted tow rope system 200 organized. For example, the storage strap 234 may be utilized to keep the storage pouch 232 and the rope 236 coupled to one another. The rope 236 may include two or more outer protective layer(s) 238 that allow for the rope 236 to flex but to not flex beyond the strain level of the strip and/or light source.

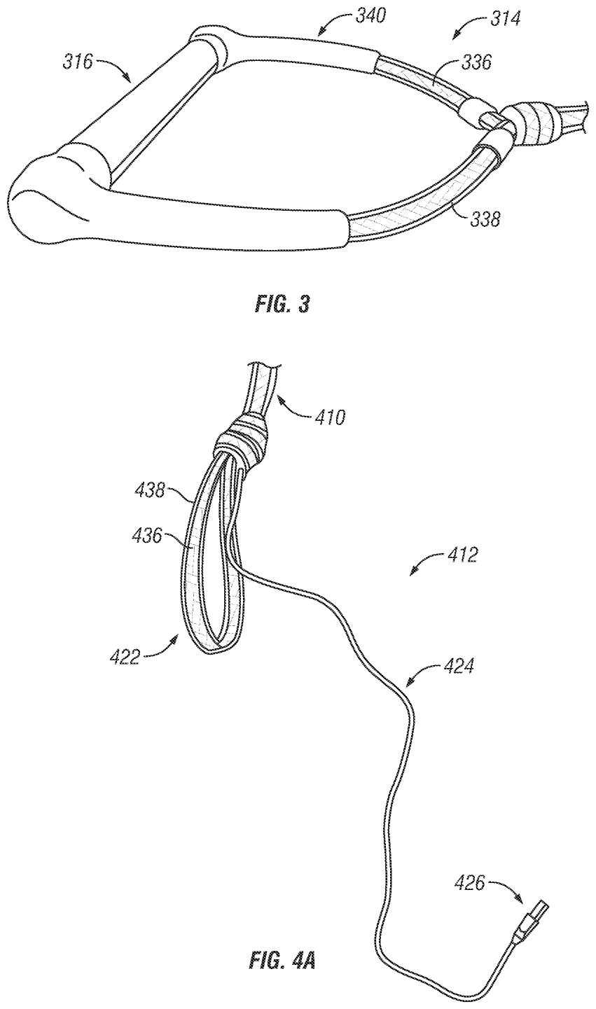

FIG. 3 is a perspective view illustration of a handle 314. The handle 314 in at least one embodiment may connect a handle bar 316 and a rope 336. In at least one example, the handle bar 316 is straight; however, a rounded, curved, triangular, and/or any combination thereof or other combinations that allow a user (not illustrated) to hold onto may be used. The handle bar 316 can be engaged with a rope 336 on at least one side. In at least one embodiment, the rope 336 may extend through the handle bar 316. For example, the handle bar 316 may have an opening on a first end, and an opening on a second end that are linked by a void that the rope 336 can pass through.

The rope 336 can have outer protective layer 338 that prevent water, and/or other chemicals or actions to damage the rope 336. For example, the outer protective layer 338 may prevent Ultraviolet light damage from occurring to the rope 336. In at least one embodiment, the out protective layer 338 is at least two layers thick. Similarly, to protect a user, the handle bar 316, and/or the rope 336 one or more protective couplings 340 may be utilized to prevent a user and/or the rope 336 from being damaged with the handle bar 316 hits a surface or other item.

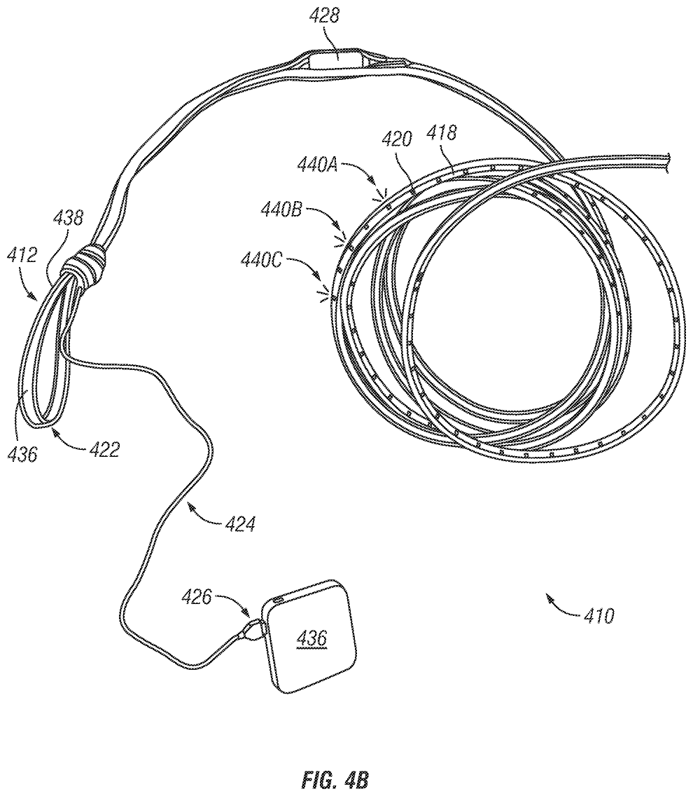

FIG. 4A is a perspective view illustration of a rope end 412 of a tow rope 410. The rope end 412 of tow rope 410, in at least one example may be called a tow end of the tow rope 410. The rope end 412 may have a loop 422. The loop 422 can allow for the tow rope 410 to be connected to various devices, toys, tubes, tow systems, connectors, connection systems, other tow ropes, and/or any components that allow for the tow rope 410 to be connected to another object. In at least one embodiment, the tow rope 410 may have a rope portion 436 that can be surrounded by an outer protective layer 438. In at least one example, the out protective layer(s) 438 may include two or more layers of protection. A cable 424 may also be contained within the outer protective layer(s) 438, in close proximity to the rope 436. The cable 424, in at least one embodiment, may connect to electronic elements housed within the outer protective layer(s) 438. A connector 426 may allow the cable 424 to connect to power sources, computing devices, and/or other components capable of receiving or sending elements.

FIG. 4B is a perspective view illustration of a rope end 412 of a tow rope 410. The rope end 412 of tow rope 410, in at least one example may be called a tow end of the tow rope 410. The rope end 412 may have a loop 422. The loop 422 can allow for the tow rope 410 to be connected to various devices, toys, tubes, tow systems, connectors, connection systems, other tow ropes, and/or any components that allow for the tow rope 410 to be connected to another object. In at least one embodiment, the tow rope 410 may have a rope portion 436 that can be surrounded by an outer protective layer 438.

In at least one example, the outer protective layer(s) 438 may include two or more layers of protection. The outer protective layer(s) 438 can be provide protection for a strip 418 and/or one or more light source(s) 420. In at least one embodiment, a strip 418, which is meant to mean a strip comprising electrical components, may have an outer protective layer 438 surrounding it, with another outer protective layer 438 surrounding the rope 436, strip 418 and outer protective layer 438, and any light source(s) 420 coupled to the strip 418. The various protective layer(s) 438 allow for the strip 418 to be protected from flexing beyond its desired flex point. In some examples, the strip 418 may break when flexed more than ninety (90) to one hundred and twenty (120) degrees over a length of five (5) or less (where less could be any value between five feet and one inch). In yet more examples, the strip 418 should not be flexed beyond ninety (90) degrees over a length of thirty-six (36) inches or up to five (5) feet. The multiple outer protective layer(s) 438 assists in preventing the strip 418 from being flexed beyond the breaking point of the strip 418.

The strip 418 and/or light source 420 may be coupled to a cable 424 may also be contained within the outer protective layer(s) 438, in close proximity to the rope 436 for at least a portion of the rope's length. The strip 418 can include a number of electrical components such as but not limited to light emitting diodes (LEDs), diodes, resistors, capacitors, inductors, transistors, voltage regulators, microcontrollers, processors, microprocessors, digital logic circuits, transmitters, receivers, transceivers, and/or other circuit components. In at least one embodiment, the strip 418 is coupled to a controller 428. The controller 428 may allow for the engagement and/or control of one or more light source(s) 420. The controller 428, may also in some examples, be coupled to the Cable 424. The cable 424, in at least one embodiment, may connect to electronic elements housed within the outer protective layer(s) 438. A connector 426 may allow the cable 424 to connect to power sources, computing devices, and/or other components capable of receiving or sending elements. For example, a power source 430 may be coupled to the cable 424. In at least one embodiment, the connector 426 of the cable 424 engages with a port or other opening of the power source 430 to couple power to the cable 424. The power may be supplied to the strip 418 and/or controller 428, to allow for the one or more light sources 420 or other circuit components to receive voltage or current has needed and/or designed. In at least one example, the controller 428 can cause light source(s) 420 to light in various orders, combinations, and/or colors. The light source(s) 420 may be a single color or multiple colors. For example, Light projection 440A may be red, while light projection 440B is white, and light projection 440C is blue, in other examples light projection 440A may be on, while light projections 440B and light projection 440C are off until light projection 440A is turned off. It would be understood that other colors, combinations, and/or orders may be utilized.

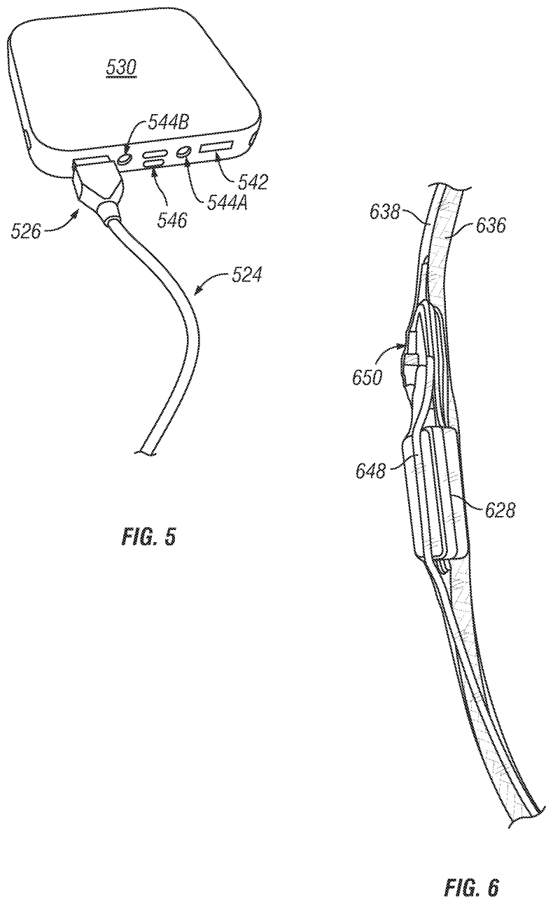

FIG. 5 is an illustration of a power source 530. In at least one embodiment, the power source 530 can be coupled to a cable 524. The cable 524 allows for the transfer of power from the power source 530 to a circuit, controller, and/or light source (not illustrated). In at least one example, the cable 524 can have a connector 526 that allows for the transfer of power from the power source 530 to the cable 524. The power source 530 may have multiple ports, openings, apertures, voids, and/or other manners, means, or methods to engage a cable 524 and/or connector 526 with the power source 530. For example, a power output 546 (it would be understood that a similar power output port would be where the connector 526 is plugged in for illustration purposes) may allow for power to be added and/or the charging of the power source 530. Similarly, there may be power jack(s) 544A/544B of different styles and/or types allowing for different connections and devices to be powered from the power source 530. There may also be power input 546 of similar or different types than the power output(s) 542. In at least one example, the power output(s) 542 may be a form of USB, USB-C, or other substantially rectangular power jacks. While the power jack(s) 544A/544B may be substantially circular. In at least one example, the power jacks 544A/544B may allow for an audio input and/or audio output to run through the power source 530 to cause a controller or other device to change light source(s) based on musical cues.

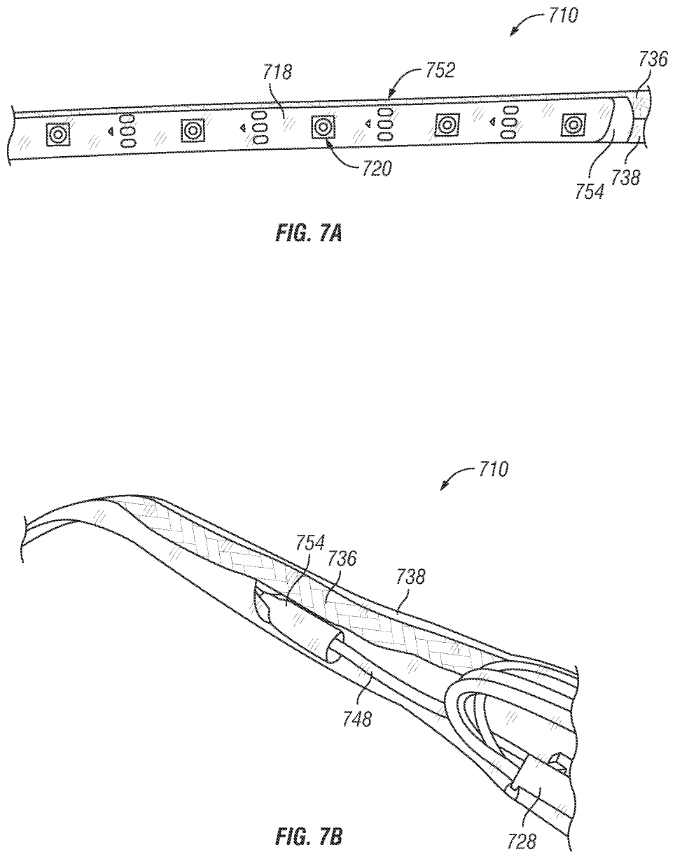

FIG. 6 is an illustration of a controller 628 of a tow rope. The controller 628 in at least one embodiment, allows for the controller of one or more light sources (not illustrated) coupled to the tow rope. The controller 628 may allow for light sources to be controlled individually, in combination, or as one unit for intensity of light output, and/or color. Similarly, the controller 628 may cause individual light sources to change based on music, a set pattern, a user-controlled pattern, and/or any other combinations.

The controller 628 may be surrounded by an outer protective layer 638. The outer protective layer 638 can protect the controller 628 from the elements, while also allowing the controller 628 to be engaged with a rope 636 to prevent movement of the controller 628. The controller 628 may be coupled to a strip, light sources, and/or circuit elements through a wire 648 and/or coupling 650. In at least one example, the wire 648 can allow for a transfer or engagement along a length of the rope 636 while the coupling 650 allows for a quick connect or disconnect.

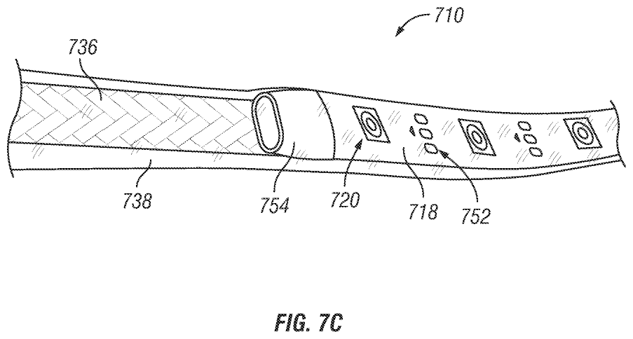

FIG. 7A is a magnified top view of a tow rope 710. The tow rope 710 can include a rope 736 that is in close proximity with other components. For example, a strip 718 may be in close proximity with the rope 736. The strip 718 may include one or more light source(s) 720. The light source(s) 720 may receive power from an electrical circuit 752 that allows for power and/or energy to be passed from a power source (not illustrated) to the light source(s) 720. In at least one embodiment, the electrical circuit 752 can allow for control and/or activation of the light source(s) 720 based on a controller or device presenting a control signal.

The strip 718, the rope 736, light source(s) 720, and/or electrical circuit(s) 752 may be encompassed by protective layer(s) 754, and/or outer protective layer(s) 738. The protective layer(s) 754 allow for an internal protection of the strip 718, light source(s) 720, and/or electrical circuit(s) 752 in a manner that can prevent the breaking of the strip 718, light source(s) 720, and/or electrical circuit(s) 752. The outer protective layer 738 can allow for additional protection of strip 718, light source(s) 720, and/or electrical circuit(s) 752 while also protecting the rope 736 as well.

FIG. 7B is a magnified top view of a tow rope 710. The tow rope 710 can include a rope 736 that is in close proximity with other components.

The strip, the rope 736, light source(s), and/or electrical circuit(s) may be encompassed by protective layer(s) 754, and/or outer protective layer(s) 738. The protective layer(s) 754 allow for an internal protection of the strip, light source(s), and/or electrical circuit(s) in a manner that can prevent the breaking of the strip, light source(s), and/or electrical circuit(s). The outer protective layer 738 can allow for additional protection of strip, light source(s), and/or electrical circuit(s) while also protecting the rope 736 as well.

The controller 728 may allow for the engagement and/or control of one or more light source(s) 720. The power may be supplied to the strip 718 and/or controller 728, to allow for the one or more light sources 720 or other circuit components to receive voltage or current has needed and/or designed. In at least one example, the controller 728 can cause light source(s) 720 to light in various orders, combinations, and/or colors. The light source(s) 720 may be a single color or multiple colors. The controller 728 may be coupled to a strip, light sources, and/or circuit elements through a wire 748 and/or coupling 750. In at least one example, the wire 748 can allow for a transfer or engagement along a length of the rope 736 while the coupling 750 allows for a quick connect or disconnect.

FIG. 7C is a magnified top view of a tow rope 710. The tow rope 710 can include a rope 736 that is in close proximity with other components. For example, a strip 718 may be in close proximity with the rope 736. The strip 718 may include one or more light source(s) 720. The light source(s) 720 may receive power from an electrical circuit 752 that allows for power and/or energy to be passed from a power source (not illustrated) to the light source(s) 720. In at least one embodiment, the electrical circuit 752 can allow for control and/or activation of the light source(s) 720 based on a controller or device presenting a control signal.

The strip 718, the rope 736, light source(s) 720, and/or electrical circuit(s) 752 may be encompassed by protective layer(s) 754, and/or outer protective layer(s) 738. The protective layer(s) 754 allow for an internal protection of the strip 718, light source(s) 720, and/or electrical circuit(s) 752 in a manner that can prevent the breaking of the strip 718, light source(s) 720, and/or electrical circuit(s) 752. The outer protective layer 738 can allow for additional protection of strip 718, light source(s) 720, and/or electrical circuit(s) 752 while also protecting the rope 736 as well.

The controller 728 may allow for the engagement and/or control of one or more light source(s) 720. The power may be supplied to the strip 718 and/or controller 728, to allow for the one or more light sources 720 or other circuit components to receive voltage or current has needed and/or designed. In at least one example, the controller 728 can cause light source(s) 720 to light in various orders, combinations, and/or colors. The light source(s) 720 may be a single color or multiple colors. The controller 728 may be coupled to a strip, light sources, and/or circuit elements through a wire 748 and/or coupling 750. In at least one example, the wire 748 can allow for a transfer or engagement along a length of the rope 736 while the coupling 750 allows for a quick connect or disconnect.

While this disclosure has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

We claim:

1. A system for a tow rope comprising: a length of rope; a strip comprising at one light source;
wherein the strip is of a length that is less than the length of rope; a control system coupled to the at least one light source; a set of protective layers surrounding the strip and engaging the strip with the length of rope; wherein the set of protective layers are sufficient to prevent the strip from breaking when flexed.

2. The system of claim 1, wherein the rope comprises a first end and second end in which the first end comprises a loop and the second end comprises a handle.

3. The system of claim 1, wherein the protective layer is of a sufficient thickness to allow the rope to flex at ninety degrees over a length of five feet.

4. The system of claim 1, wherein the control system, and light source are contained within the protective layers.

5. The system of claim 2, wherein the handle and loop are not contained within the protective layers

6. The system of claim 2, wherein the control system is positioned proximal to the front end.

7. The system of claim 1, wherein the at least one light source is connected to the control system.

8. The system of claim 1, wherein the control system manipulates the at least one light source.

9. The system of claim 1, wherein the at least one light source is illuminated when plugged into the power source.

10. A tow rope comprising: a length of rope; a strip comprising at one light source; wherein the strip is of a length that is less than the length of rope; a control system coupled to the at least one light source; a set of protective layers surrounding the strip and engaging the strip with the length of rope; wherein the set of protective layers are sufficient to prevent the strip from breaking when flexed.

11. The apparatus of claim 10, wherein the set of protective layers have a cylindrical structure.

12. The apparatus of claim 10, wherein the power source is a direct current voltage source.

13. The apparatus of claim 10, wherein the length of rope comprises a first end and a second end.

14. The apparatus of claim 13, wherein the first end comprises a gap between the protective layer and rope in which a connector is fed from control system to a power source.

15. The apparatus of claim 10, wherein the set of protective layers engage, at minimum, a portion of the length of rope comprising the strip and control system.

16. The apparatus of claim 10, wherein the protective layers are constructed to a certain stiffness with the ability to flex less than 45 degrees over a length of five feet.

17. A method for lighting a tow rope comprising: trimming a length of rope; preparing a strip comprising at one light source; wherein the strip is of a length that is less than the length of rope; coupling a control system to the at least one light source; surrounding the strip with a set of protective layers; and engaging the strip with the length of rope; wherein the set of protective layers are sufficient to prevent the strip from breaking when flexed.

18. The method of claim 17, wherein engaging comprising surrounding the length of rope and the strip with an outer protective layer.

19. The method of claim 17, further comprising building the set of protective layers to a sufficient thickness that the length of rope can flex less than 90 degrees over five feet.

20. The method of claim 17, further comprising electrifying the strip, and control system with at least one power source.
